(19) United States
(12) Patent Application Publication
(10) Pub. No.: US 2026/0079381 A1
(43) Pub. Date: Mar. 19, 2026

(54) Deterministic Optical Logic System Based on the Total Wave Modified Schrödinger Equation (TWMSE) and Generalized Interference Logic

(71) Applicant: LARRY LIM KHENG CHEONG, SINGAPORE (SG)

(72) Inventor: LARRY LIM KHENG CHEONG, SINGAPORE (SG)

(21) Appl. No.: 19/250,125

(22) Filed: Jun. 26, 2025

(51) Int. Cl. G02F 3/00; G06E 1/04

(52) U.S. Cl. CPC G02F 3/00; G06E 1/04

(57) ABSTRACT

We propose a hybrid wave-based logic model for optical computing that integrates both Total Wave Modified Schrödinger Equation (TWMSE) formulations and non-TWMSE interference field logic. This system enables deterministic collapse behavior through physical wave interactions, rather than relying on conventional transistor logic or probabilistic quantum models. In the TWMSE regime, collapse thresholds are governed by field interference between signal and control waves, allowing dynamic selection of tasks based on intensity and phase alignment. In the generalized non-TWMSE regime, similar collapse-like logic can be achieved using thresholded interference models that are classically engineered for optical domain systems. Together, these formulations enable adaptive task selection, nonlinear logic gating, and scalable parallel processing in optical chips. Our architecture supports real-time wavefield decisions and is compatible with standard photonic components such as interferometers, microring resonators, variable attenuators, and optical threshold comparators. The result is a unified logic framework for next-generation AI hardware that harnesses both quantum-inspired and classical wave interference dynamics.

This application claims priority to and incorporates by reference the research disclosed in Zenodo publications: DOI 10.5281/zenodo.15509320, 10.5281/zenodo.15534245, 10.5281/zenodo.15510492, 10.5281/zenodo. 15524071, 10.5281/zenodo.15552673, and 10.5281/zenodo.15296796.

### FIELD OF THE INVENTION

The present invention relates to optical computing systems, and more specifically, to a deterministic logic framework for photonic signal processing based on the Total Wave Modified Schrödinger Equation (TWMSE). The invention introduces field-based collapse thresholds for dynamic task routing and signal selection in massively parallel photonic computing architectures.

### BACKGROUND OF THE INVENTION

Conventional optical computing systems rely on fixed routing, binary logic gates, and clocked architectures, even though light inherently supports interference-based computation. While recent photonic processors such as Meteor-1 enable parallel channel utilization, their logical control mechanisms are typically static or externally clocked. This disconnect limits adaptive task selection and scalability in AI and high-throughput environments.

There remains a need for a native wave-based logic framework that operates within optical media and resolves computation dynamically based on interference and collapse logic.

### SUMMARY OF THE INVENTION

The invention provides a method and system for deterministic optical logic based on the Total Wave Modified Schrödinger Equation (TWMSE). The system replaces Boolean gate logic with threshold-based collapse mechanisms that dynamically select, route, or suppress optical signals based on real-time interference conditions.

In particular, the invention enables task-specific wavefields (signals) to interact with weighted control wavefields (observers), where the outcome of their interference is evaluated by a collapse function C(r,t). The result determines whether a signal is activated (collapsed) or suppressed. This approach supports massively parallel, real-time, low-latency decision making using photonic hardware.

The TWMSE framework governs signal evolution via:

$$i \partial Ψ p \partial t = ( D ∇ 2 + Veff + C ( r , t ) ) Ψ pi ∖ frac \{ ∖ partial ∖ Psi\_p \} \{ ∖ partial t \} = ∖ left ( D ∖ nabla \hat{} 2 + V\_ \{ ∖ text \{ eff \} \} + C ( r , t ) ∖ right ) ∖ Psi\_p$$

Where C(r,t) is defined as:

$$C ( r , t ) = \sum j [ γ j \vert Ψ j \vert 2 - δ j ( Ψ j ) ] Ψ p * C ( r , t ) = ∖ sum\_j ∖ left [ ∖ gamma\_j \vert ∖ Psi\_j \vert \hat{} 2 - ∖ delta\_j ∖ Re ( ∖ Psi\_j ) ∖ right ] ∖ Psi\_p {\hat{}}^{*}$$

Collapse occurs when the computed interference field C(r,t) exceeds a tunable threshold θcollapse\theta_{\text{collapse}}. The control waves Ψj\Psi_j represent external wavefronts or logic inputs, and their magnitude and phase are weighted by coefficients γj,δj\gamma_j, \delta_j.

In optical terms, each component is mapped to physical hardware:
Ψp\Psi_p: signal beams encoded via frequency or spatial channels
Ψj\Psi_j: control beams injected into waveguides
γj\gamma_j: amplitude modulators
δj\delta_j: phase modulators or microrings
θ\theta: optical threshold (e.g., via saturable absorber or nonlinear node)

The system supports high-speed task arbitration, routing, and logical filtering across hundreds to thousands of channels simultaneously, with minimal power dissipation.

This invention may be implemented using Mach-Zehnder interferometers, ring resonators, splitters, combiners, saturable absorbers, or phase-tunable waveguide structures fabricated using silicon photonics, III-V materials, or hybrid integration platforms.

The resulting platform offers deterministic, adaptive, and fully field-governed optical computation for AI inference, signal processing, cryptography, and other computational workloads.

Additional embodiments include dynamic tuning of the threshold θ\theta via optical feedback, environmental sensing, or AI supervision; support for analog or multivalued signal logic; and use of programmable control waveforms to induce specific collapse patterns across chip regions.

These and other advantages will become apparent from the detailed description of the preferred embodiments.

1. A system for deterministic optical logic, comprising:
an optical signal wave Ψₚ;
one or more control waves Ψⱼ;
a collapse evaluation module configured to compute
$$C ( r , t ) = {\sum }_{j} [ {γ}_{j} {\vert {Ψ}_{j} \vert}^{2} - {δ}_{j} ( {Ψ}_{j} ) ] {Ψ}_{p}^{*}$$
where γⱼ and δⱼ are weighting coefficients; and
a threshold module comparing C(r, t) against θ_{collapse} to trigger logical selection, activation, or suppression,
wherein signal processing is governed by interference between Ψₚ and Ψⱼ in accordance with a Total Wave Modified Schrödinger Equation.

2. The system of claim 1, wherein said γⱼ values are tuned via amplitude modulators.

3. The system of claim 1, wherein said δⱼ values are tuned via phase modulators or microring resonators.

4. The system of claim 1, wherein said θ_{collapse} is tunable in real time via optical feedback.

5. The system of claim 1, further comprising waveguide channels structured to carry said Ψₚ and Ψⱼ as coherent photonic signals.

6. The system of claim 1, wherein said collapse evaluation and logic are implemented in a photonic integrated circuit.

7. The system of claim 1, wherein said logic governs AI decisioning, filtering, or dynamic task routing.

8. The system of claim 1, wherein said computation supports analog or multivalued outcomes based on the magnitude of C(r, t) relative to threshold levels.

9. The system of claim 1, wherein said collapse dynamics are determined without explicit Boolean logic.

10. The system of claim 1, wherein said interference-based logic replaces digital clocking with field evolution.

11. A method of optical computation, comprising:
encoding a signal as Ψₚ and controls as Ψⱼ;
evaluating the field interference C(r, t);
comparing said C(r,t) to θ_{collapse};
activating or suppressing Ψₚ accordingly,
wherein all computations are performed by field interactions.

12. The method of claim 11, wherein the evaluation of C(r, t) is performed in real time on a photonic substrate.

13. The method of claim 11, wherein said γⱼ and δⱼ coefficients are programmable.

14. The method of claim 11, wherein said method enables selective photonic computation without classical gates.

15. A photonic processor comprising a plurality of wave emitters generating Ψⱼ signals, and a signal path Ψₚ, coupled through interference to implement logic based on the Total Wave Modified Schrödinger Equation.

16. The processor of claim 15, wherein said logic is realized via interference collapse field C(r, t) as defined in the Specification.

17. The processor of claim 15, wherein said interference produces deterministic outcomes suitable for neuromorphic or quantum-inspired computation.

18. The processor of claim 15, wherein interference evaluation is performed via field thresholding rather than sampling.

19. A non-TWMSE implementation of claims 1-18 wherein the collapse function C(r, t) is computed using any functional field interference metric, thresholded for logical operations without reliance on Schrödinger-type evolution.

20. The system of claim 19, wherein said non-TWMSE interference logic employs cosine-weighted real-time projections, phase synchronization, or other field-comparison mechanisms.
